(19) United States
(12) Patent Application Publication
(10) Pub. No.: US 2008/0062328 A1
(43) Pub. Date: Mar. 13, 2008

(54) Signal format selection based on physical connections

(76) Inventor: Brett Bilbrey, Sunnyvale, CA (US)

Correspondence Address: FISH & RICHARDSON P.C., PO BOX 1022, MINNEAPOLIS, MN, 55440-1022, US

(21) Appl. No.: 11/519,311

(22) Filed: Sep. 11, 2006

(51) Int. Cl. H04N 3/27; H04N 5/268

(52) U.S. Cl. 348/705; 348/554

(57) ABSTRACT

A device detects one or more physical connections and selects a signal format from a plurality of signal formats based on the one or more physical connections.

### TECHNICAL FIELD

The subject matter of this application is generally related to consumer electronics.

### BACKGROUND

Composite video is the format of an analog television picture signal before it is combined with a sound signal and modulated onto a radio frequency (RF) carrier. It is usually in a standard format such as NTSC, PAL or SECAM. A composite video signal is a composite of three source signals called Y, U, and V with synchronization pulses. Y represents brightness or luminance of the picture and includes the synchronization pulses. U and V carry color information. Y. U and V are combined to provide a composite video signal which can be directed to a broadcast channel by modulating the proper RF carrier frequency with the composite video signal. In many home applications, the composite video signal is connected using an RCA jack. However, BNC connectors and higher quality co-axial are often used in professional applications. In Europe, SCART connections are often used instead of RCA jacks.

Component video is a type of analog video information that is transmitted or stored as two or more separate signals. Component video can be contrasted with composite video in which the video information is combined into a one signal such as a TV broadcast. The component signals YPrPb are typically derived from Red, Green and Blue (RGB) colors captured by a scanner, digital camera or other image capture device. Y represents brightness or luminance and Pr and Pb represent color difference signals.

Consumer electronic devices that process component video signals (e.g., DVD players, plasma displays, video beamers) typically provide three separate connections for video component channels. To remain compatible with composite video devices and other popular video formats (e.g., HDMI, S-Video), physical connections for video component channels are included in an interface. For devices with small form factors, manufacturers often include physical connections for a limited number of standard video formats, and then rely on external dongles or other devices to provide the excluded video formats.

### SUMMARY

A device detects one or more physical connections and selects a signal format from a plurality of signal formats based on the one or more physical connections.

In some implementations, an apparatus includes a plurality of channels configured for physical connection to a device. A detector is operatively coupled to the channels, and is configured for detecting one or more physical connections of one or more of the channels to the device. A processor is operatively coupled to the detector and configured for determining a signal format from a plurality of signal formats based on the one or more detected physical connections.

In some implementations, a method includes: detecting one or more physical connections of one or more channels of a first device; and

determining a signal format from a plurality of signal formats based on the one or more physical connections.

In some implementations, a system includes a receiver configured to receive a broadcast signal. A plurality of channels are operatively coupled to the receiver and configured for physical connection to a device. A detector is operatively coupled to the channels, and is configured for detecting one or more physical connections of one or more of the channels to the device. A processor is operatively coupled to the detector and configured for determining a signal format for the broadcast signal based on the one or more detected physical connections.

In some implementations, an apparatus includes a plurality of channels configured for physical connection to a device. A detector is operatively coupled to the channels, and is configured for detecting one or more physical connections of one or more of the channels to the device. An interface is operatively coupled to the detector and configured for coupling with a processor and receiving one or more signals from the processor for determining a signal format based on the one or more detected physical connections.

Other implementations of signal format selection based on physical connections are disclosed which are directed to systems, methods and apparatuses.

### DESCRIPTION OF DRAWINGS

FIG. 1 is a block diagram of an exemplary signal transmission system.

FIG. 2 is a diagram of an exemplary interface for the first device of FIG. 1.

FIG. 3 is a flow diagram of a process for selecting a signal format based on a physical connection.

FIG. 4 is a block diagram of an exemplary architecture for the first device of FIG. 1.

### DETAILED DESCRIPTION

### System Overview

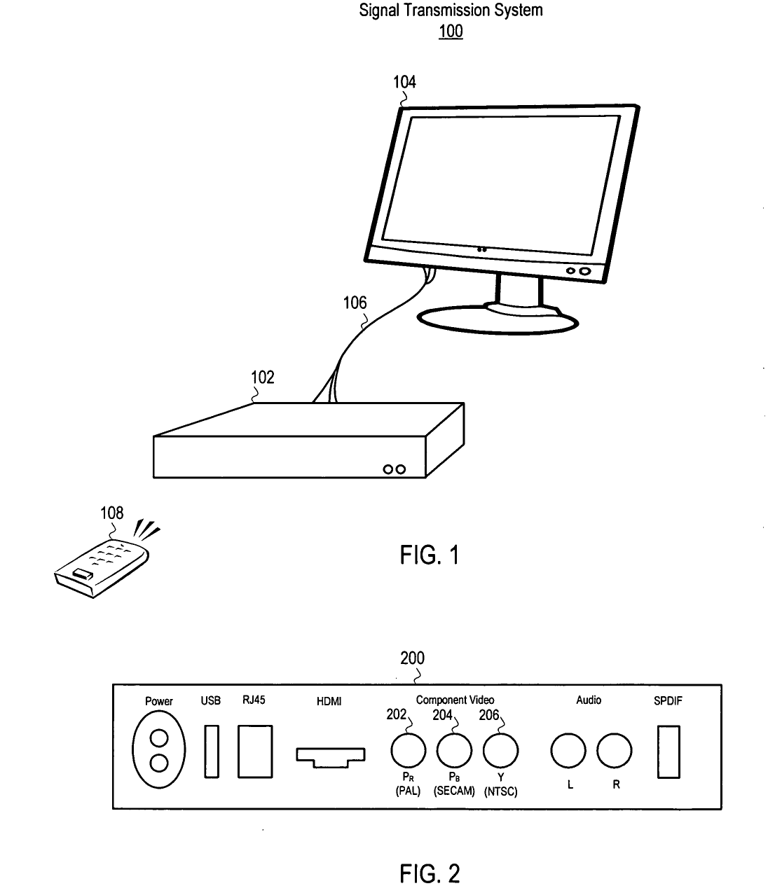

FIG. 1 is a block diagram of an exemplary signal transmission system 100. In some implementations, the system 100 includes a first device 102 and a second device 104. One or more cables 106 connect the first device 102 to the second device 104. The system 100 can optionally include a remote control device 108 for controlling the first device 102 and/or the second device 104.

The first device 102 and the second device 104 can be any device capable of providing or receiving signals, including but not limited to: personal computers, digital video cameras, digital recorder/players, set-top boxes, television systems, digital television (DTV) devices, DVD players, projectors, video cassette recorders (VCR), game consoles, media players, video cards, storage devices, hubs, routers, switches, network adapters, media center devices, kiosks, mobile phones, personal digital assistants (PDAs), computer monitors, liquid crystal displays (LCDs), plasma screens, video beamers, etc.

The cables 106 are for making physical connections between the first device 102 and the second device 104. Depending on the number and types of signals (e.g., video, audio, analog, digital, optical), the cables 106 include a variety of standard configurations, including but not limited to: video component cables, Bayonet Neill Concelman (BNC) connectors, coaxial cables, Video Graphics Array (VGA) connectors, RCA connectors, Sony/Philips Digital Interface (SPDIF), Universal Serial Bus (USB), FireWire®, Ethernet cables, RJ45 connectors, phone jacks, Digital Video Interface (DVI), High-Definition Multimedia Interface (HDMI), etc.

In the example shown, the first device 102 is a video output device and the second device is a display device 104. The first device 102 provides video output signals to the second device 104 in one or more video formats (e.g., component video, NTSC, PAL, SECAM) based on one or more physical connections between the cables 106 and one or more output channels of the first device 102. The process of selecting a signal format based on physical connections is applicable to any system or device capable of transmitting and/or receiving multiple signal formats. Moreover, physical connections can be made with input, output or through channels of the system or device.

The description that follows refers to video systems and signals. It should be apparent, however, that the disclosed implementations are equally applicable to other types of systems and signals.

### Signal Interface Example

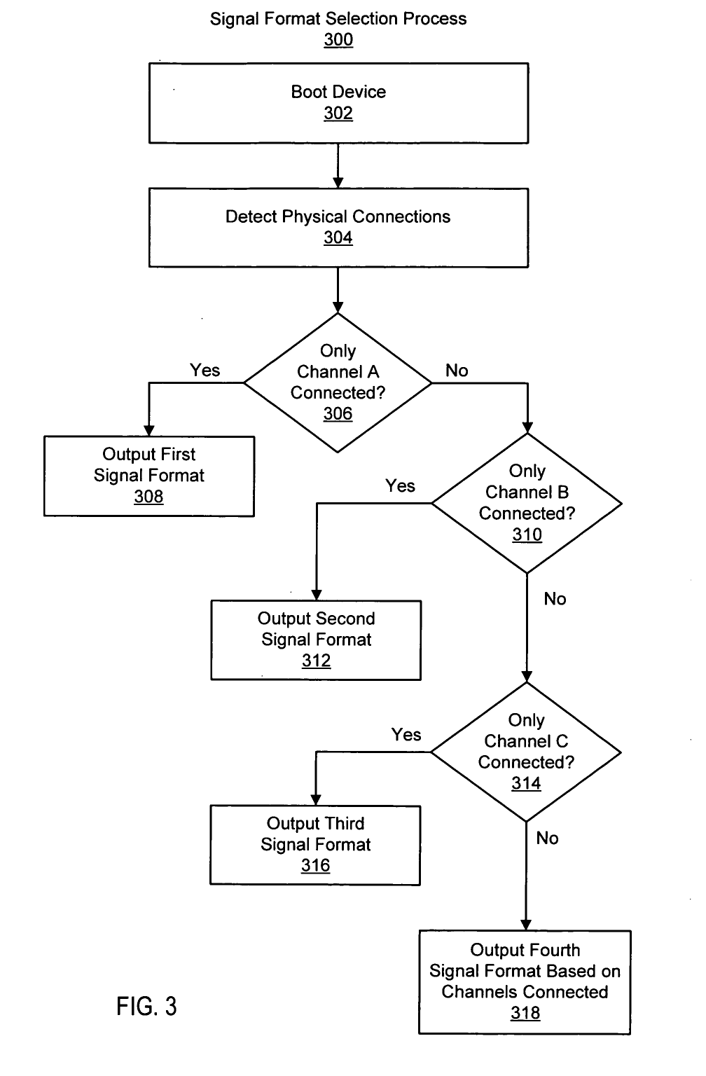

FIG. 2 is a diagram of an exemplary signal interface 200 for the first device 102 of FIG. 1. In the example shown, the interface 200 is the back panel of the first device 102. Other locations for the interface 200 are possible. The interface 200 includes various connectors for power, USB, Ethernet, HDMI, audio and SPDIF. In addition to these connections, the interface 200 includes component video connectors 202, 204 and 206, for providing component video output. In some implementations, the connector 202 is coupled to a first output channel for providing a first color difference signal “Pr,” the connector 204 is coupled to a second output channel for providing a second color difference signal “Pb” and the connector 206 is coupled to a third output channel for providing a luminance signal “Y.” As will be discussed in reference to FIG. 3, the connector 202 can also provide a composite video signal in the PAL format, the connector 204 can also provide a composite video signal in the SECAM format and the connector 206 can also provide a composite video signal in the NTSC format.

Video signal formats can be assigned to the connectors 202, 204 and 206 in any desired manner. The assignments can be hardwired or programmed using configuration information received from the remote control 108, a network or from hardware controls on the device 102 (e.g., a switch or button). For example, the connector 202 can be assigned to the output channel for providing the luminance signal “Y,” the connector 204 can be assigned to the output channel for providing the color difference signal “Pr” and the connector 206 can be assigned to the output channel for providing the color difference signal “Pb.” In some implementations, a video signal format can be assigned to more than one output channel. For example, the connectors 202 and 206 can be assigned to the “Pr” and “Y” channels, respectively, for providing S-Video.

### Process Flow Example

FIG. 3 is a flow diagram of a process 300 for selecting a signal format based on one or more physical connections. In some implementations, the process 300 begins when a device boots up (302). The process 300 can also be initiated during re-boot, power-up, initialization and/or in response to a trigger event. For this example, it is assumed that the user has connected a cable (made a physical connection) to at least one of three channels A, B and C prior to the device booting. The channels A, B and C can be, for example, video component channels Y, Pr and Pb, respectively, as shown in FIG. 2.

During booting of the device (or other trigger event), a detector in the device detects physical connections to the channels A, B and C (304). A channel that is physically connected to another device through a cable will exhibit an impedance value that is different than if the channel was not physically connected (e.g., an open circuit). In some implementations, the detection is performed by sensing “loads” on one or more of the channels A, B and C. Various known “load” sensing circuits can be used for sensing loads, including, for example, a sense resistor which senses a voltage drop when current is drawn through it by a load. In some implementations, a “load” sensing circuit can be part of an integrated circuit (IC) chip used for providing video signals. An example of a suitable chip with load sensing capability is the NVIDIA® GeForce® Go 7400 (G72M) graphics processing unit, developed by NVIDIA® Corporation (Santa Clara, Calif.). Other chips with similar capability can also be used.

If the detector detects that only channel “A” is physically connected (306), and no other channels are connected, then the device will output a signal having a first signal format on channel “A” (308). If the detector detects that only channel “B” is physically connected (310), and no other channels are connected, then the device will output a signal having a second signal format on channel “B” (312). If the detector detects that only channel “C” is physically connected (314), and no other channels are connected, then the device will output a signal having a third signal format on channel “C” (316). If all three channels “A,” “B” and “C” are physically connected, then the device will output signals having a fourth signal format on two or three of the channels “A,” “B” and “C” depending on the signal format (318). For example, if the signal format is component video, then all three channels “A,” “B” and “C” are used to output the component video signals. If the signal format is S-Video, then two of the channels (e.g., Pr, Y channels) are used to output the S-Video signals.

The process 300 described above can be applied to the interface 200 and video component connectors 202, 204 and 206. In this example, it is assumed that the user has connected one end of a composite video cable 106 (e.g., a cable with a yellow RCA jack) to the connector 206 in the interface 200 of the first device 102 and the other end to the second device 104. The second device 104 can be, for example, a computer display capable of receiving a composite video signal in NTSC format. When the first device 102 is booted or otherwise initialized, a load sensing device in the first device 102 detects a load on the connector 206, but does not detect loads on the connectors 202 and 204. As a result of the detection, a processor and/or other circuitry in the first device 102 selects an NTSC video signal for output on the luminance component channel “Y” coupled to the connector 206. The signal can be a “live” broadcast signal or it can be a signal retrieved from a storage device (e.g., a hard disk, DVD).

In another example, it is assumed that the user has connected all three connectors 202, 204 and 206, to a second device 104 that is capable of receiving component video “YPrPb.” In this case, the first device 102 detects loads on all three component video channels and selects component video signals for output on the video component channels “Pr,” “Pb,” and “Y” coupled to connectors 202, 204 and 206, respectively.

Similarly, if the user wants to output a video signal in PAL or SECAM formats, the user can connect the appropriate cable to connector 202 or connector 204, respectively, and leave the other video component channels disconnected. In the event that two channels are physically connected, the interface 200 can be configured to provide a default signal (e.g., NTSC).

In some implementations, the second device 104 can include an interface 200 for receiving video signals in various formats. In this case, the physical connections to connectors 202, 204 and 206, can be used to determine a format of a received video signal. For example, if only the luminance channel “Y” is physically connected to the second device 104, then the second device 104 can expect to receive an NTSC signal through the connector 206.

### Device Architecture Example

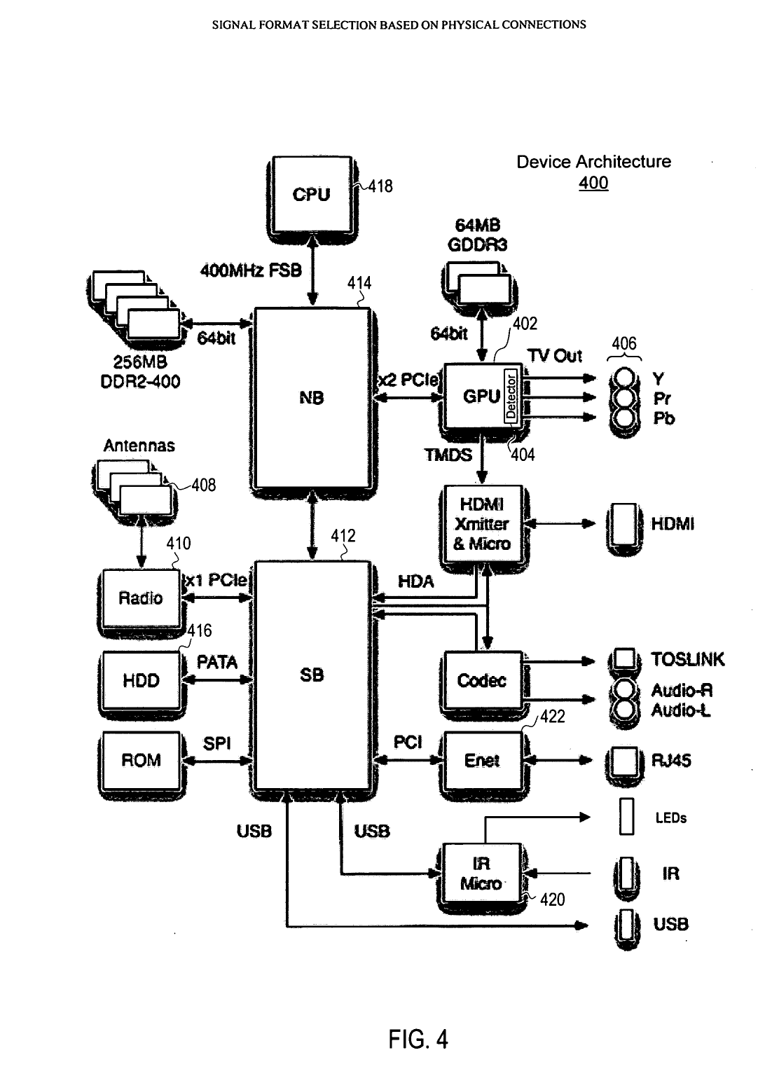

FIG. 4 is a block diagram of an exemplary device architecture 400 for implementing the process 300 of FIG. 3. In some implementations, the architecture 400 includes a graphics processing unit (GPU) 402, TV output 406 (e.g., YPrPb), antennas 408, radio frequency (RF) receiver 410, south bridge 412, north bridge 414, storage device 416 (e.g., a hard disk, flash memory), central processing unit 418 (e.g., an Intel® Core™ Duo processor), infrared (IR) signal processor 420 and network interface 422 (e.g., Ethernet interface). Other components can be included in the architecture 400, including but not limited to: memory (e.g., DRAM, ROM), an audio codec for decoding audio signals (e.g., PCM signals, MFEG-2 AAC, MP3), an HDMI transmitter for transmitting HDMI signals, and a TOSLINK® connector (e.g., JIS F05) for transmitting digital audio over optical fiber.

The architecture 400 is capable of receiving an RF carrier (e.g., a television broadcast signal), demodulating a base band signal from the RF carrier (e.g., an NTSC video signal), transforming the base band signal into a desired video signal format (e.g., component video, SECAM, PAL), and outputting the formatted video signal to another device (e.g., a display device).

In operation, an RF signal can be received through one or more antennas 408 and demodulated by the receiver 410. The demodulated signal is sent to the GPU 402 by way of the south bridge 412 and the north bridge 414 and one or more buses (e.g., PCIe buses). Television broadcast channels can be selected through an infrared remote control device and the IR signal processor 420, which can communicate with the receiver 410 through a serial bus (e.g., USB) and the south bridge 412. In some implementations, the receiver 410 can include various subsystems for demodulating and decoding television signals, such as a tuner, modulator/demodulator, amplifiers, filters, etc.

The basic management functions of the architecture 400 (e.g., managing memory and bus transactions, managing internal subsystems and storage devices, processing inputs and outputs, etc.) can be controlled by an operating system (e.g., Linux OS®) running on the central processing unit (CPU) 418. In some implementations, the south bridge 412 and north bridge 414 can be part of a core logic chipset installed on, for example, a motherboard located in the device 102. The south bridge chip 412 acts as an I/O controller hub and the north bridge chip 414 acts a memory controller hub. Other architectures 400 are possible including architectures with more or fewer components, subsystems, etc. For example, the south bridge chip 412 and north bridge chip 414 can be included on the same die.

In some implementations, the GPU 402 (e.g., nVIDIA® GeForce® GPU) includes a detector 404 for detecting physical connections, as described in reference to FIG. 3. The GPU 402 can also execute instructions for outputting signals in a variety of video formats (e.g., NTSC, component video, PAL, SECAM).

The network interface 422 is configured for connecting the first device 102 to a network (e.g., LAN, Internet) through an RJ45 jack. The network interface 422 can receive configuration information for mapping the TV output 406 to standard video formats based on the presence of certain physical connections which are defined by the configuration data.

Various modifications can be made to the disclosed implementations and still be within the scope of the following claims.

What is claimed is:

1. An apparatus, comprising:
a plurality of channels configured for physical connection to a device;
a detector operatively coupled to the channels, the detector configured for detecting one or more physical connections of one or more of the channels to the device; and
a processor operatively coupled to the detector and configured for determining a signal format from a plurality of signal formats based on the one or more detected physical connections.

2. The apparatus of claim 1, where the plurality of channels are video component channels.

3. The apparatus of claim 2, where if a physical connection is detected for a first video component channel, but not for second or third video component channels, a first video format is selected for output on the first video component channel.

4. The apparatus of claim 2, where if a physical connection is detected for the second video component channel, but not for the first and third video component channels, a second video format is selected for output on the second video component channel.

5. The apparatus of claim 2, where if physical connections are detected for the first, second and third video component channels, component video is selected for output on the first, second and third video component channels.

6. The apparatus of claim 2, where if physical connections are detected for the first and second video component channels, component video is selected for output on the first and second channels.

7. The apparatus of claim 6, where the component video is Super-Video (S-Video).

8. The apparatus of claim 5, where the first, second and third video components represent a color space.

9. The apparatus of claim 1, where the detector is configured to sense loads on the channels.

10. The apparatus of claim 1, where the selected signal format is from the group of signal formats consisting of: Phase Alternating Line (PAL), Sequential Couleur Avec Memoire (SECAM) and National TV Standards Committee (NTSC).

11. A method, comprising:
detecting one or more physical connections of one or more channels of a first device; and
determining a signal format from a plurality of signal formats based on the one or more physical connections.

12. The method of claim 11, further comprising:
transmitting a signal having the determined signal format to a second device using the one or more physically connected channels.

13. The method of claim 11, further comprising:
receiving a signal having the determined signal format from a second device using the one or more physically connected channels.

14. The method of claim 11, where the detecting and determining further comprises:
detecting three physically connected channels; and
determining the signal format to be a video component format.

15. The method of claim 11, where the detecting and determining further comprises:
detecting one physically connected channel; and
determining the signal format from the group of signal formats consisting of: Phase Alternating Line (PAL), Sequential Couleur Avec Memoire (SECAM) and National TV Standards Committee (NTSC).

16. The method of claim 11, further comprising:
receiving configuration information; and
determining the signal format based on the configuration information.

17. A system, comprising:
a receiver configured to receive a broadcast signal;
a plurality of channels operatively coupled to the receiver and configured for physical connection to a device;
a detector operatively coupled to the channels, the detector configured for detecting one or more physical connections of one or more of the channels to the device; and
a processor operatively coupled to the detector and configured for determining a signal format for the broadcast signal based on the one or more detected physical connections.

18. An apparatus, comprising:
a plurality of channels configured for physical connection to a device;
a detector operatively coupled to the channels, the detector configured for detecting one or more physical connections of one or more of the channels to the device; and
an interface operatively coupled to the detector and configured for coupling with a processor and receiving one or more signals from the processor for determining a signal format based on the one or more detected physical connections.

19. A computer-readable medium having instructions stored thereon, which, when executed by a processor causes the processor to perform the operations of:
detecting one or more physical connections of one or more signal channels of a first device; and
determining a signal format from a plurality of signal formats based on the one or more physical connections.

20. A system, comprising:
means for detecting one or more physical connections of one or more signal channels of a first device; and
means for determining a signal format from a plurality of signal formats based on the one or more physical connections.
